(19) United States
(12) Patent Application Publication
(10) Pub. No.: US 2008/0048936 A1
(43) Pub. Date: Feb. 28, 2008

(54) Display and display screen configured for wavelength conversion

(76) Inventors: Karlton Powell, Lake Stevens, WA (US); John R. Lewis, Bellevue, WA (US); Martin A. Kykta, Austin, TX (US)

Correspondence Address: Graybeal - Microvision, 155 108th Avenue NE, Suite 350, Bellevue, WA, 98004-5973, US

(21) Appl. No.: 11/890,798

(22) Filed: Aug. 6, 2007

Related U.S. Application Data
(60) Provisional application No. 60/837,160, filed on Aug. 10, 2006.

(51) Int. Cl. G09G 3/20

(52) U.S. Cl. 345/55

(57) ABSTRACT

A display screen includes an array of cuplets containing a wavelength converting material. The cuplets may be configured to receive light at a first wavelength and responsively emit light at a second wavelength preferentially in a direction.

### CROSS-REFERENCE TO RELATED APPLICATIONS

This application claims priority from and incorporates by reference U.S. Provisional Patent Application Ser. No. 60/837,160; filed Aug. 10, 2006; entitled DISPLAY AND DISPLAY SCREEN HAVING WAVELENGTH CONVERSION.

### BACKGROUND

Scanned beam displays generally operate by modulated a scanned beam of light in a pattern corresponding to an image to be displayed, such as a video image. According to various embodiments, the modulated beam of light may be scanned onto a display screen for viewing from the front or from the back, and/or may be scanned onto a viewer's retina.

According to some scanned beam display embodiments, an image plane or intermediate image plane (which may actually be a curved “plane”) may be formed coincident with a surface. One familiar display image plane is a display screen that may be directly viewed. Alternatively, an intermediate image plane may be formed, and the intermediate image projected onto a viewable screen via relay optics. In a retinal display, the intermediate image may be projected onto the viewer's retina.

An exit pupil expander located at an image plane or intermediate image plane in a scanned beam display may expand the exit pupil of the system. An expanded exit pupil may, according to embodiments, provide for some amount of misalignment and/or movement between the viewer's pupil and the display. In such an embodiment, which may be characteristic of a head-mounted display (HMD), a heads-up display (HUD), or other single-viewer display, it may be desirable to form an exit pupil expander at an intermediate image plane to expand the exit pupil a relatively small amount in order to maintain relatively high gain, i.e., to spread the display energy over a relatively small angle to maximize display brightness and/or minimize power consumption, size, and/or cost, etc. The image from the exit pupil expander may then be projected to the viewers' pupil(s) via refractive, reflective, and/or diffractive optics.

According to some embodiments, a display image may be simultaneously viewable by more than one viewer. According to other embodiments, a single viewer system may be configured to operate similarly to multi-viewer systems. While such embodiments may make use of an exit pupil expander at an intermediate image plane with subsequent relay optics configured to relay the expanded exit pupil to the eyes of the viewers, a more conventional approach may be to place a viewing screen at an image plane with the viewing screen being configured for direct viewing by the viewers. The viewing screen may be configured to provide gain to maximize brightness along and around a preferred axis. When configured for direct viewing, the apparent distance from the viewer to the image may be the actual physical distance from the viewer to the screen.

The image may be monochrome or multi-color. A multi-color image may be formed by modulating each of several component narrow-wavelength beams, for example. A monochrome image may be formed by modulating one or more relatively narrow (wavelength) band beams.

According to some embodiments, a monochrome or multi-color image may be formed using wavelength conversion. Wavelength conversion may, for example, make use of photoluminescent materials coated onto a screen. When a scanned beam of light at a first wavelength is projected onto a photoluminescent coating, the photoluminescent materials in the coating may absorb the light at the first wavelength and responsively emit light at a second wavelength. Typically, mechanisms for such emission are referred to broadly as photoluminescence, and may include fluorescence, phosphorescence, down-conversion (shifting wavelength from a shorter to a longer wavelength), and up-conversion (shifting wavelength from a longer to a shorter wavelength such as via a two-photon process). The first wavelength may be invisible (such as ultraviolet or infrared) or visible. Typically, the second wavelength is in the visible spectrum.

Relay optics may be considered a part of a scanned beam display and may be used in conjunction with a wide range of form factors including HMDs, HUDs, and multi-viewer systems.

### OVERVIEW

According to an embodiment, a display screen may be formed to include one or more photoluminescent materials. The term display screen as used herein may include a directly viewable screen that may be positioned at an image plane and/or a screen at an intermediate image plane of a display system. The display screen may be configured to provide gain and/or preferred optical coupling along one or more preferred output axes. The display screen may be configured to act as an exit pupil expander. The image formed at the display screen may be directly viewable and/or relayed to the viewer or viewers via relay or projection optics.

According to an embodiment, a photoluminescent display screen may include an array, including a two-dimensional array, of cuplets configured to contain one or more photoluminescent materials. The term cuplet as used herein refers to a small container or cup having a border or walls that at least partially enclose a three-dimensional volume. The array of cuplets may be formed, for example, by indenting a thermoplastic sheet of material, by casting a sheet of material to include indentations, by coating a sheet with microspheres (the spheres themselves forming the cuplets), etc. The photoluminescent display screen may receive light at a first wavelength λ₁ and convert the received light to light at a second wavelength λ₂. All or portions of the walls of the cuplets may be configured to have reflective properties operative to preferentially direct the second wavelength light along a preferred output axis or axes. All or portions of the walls of the cuplets may additionally or alternatively be configured to reflect or absorb the first wavelength to prevent leakage of the first wavelength into the viewing space.

According to another embodiment, the photoluminescent display screen may be configured to operate as an exit pupil expander (EPE). For example, the structure of the photoluminescent display screen may be configured to refract of diffract light received at wavelengths other than the first wavelength while photoluminescently emitting light at the second wavelength responsive to receiving light at the first wavelength.

According to another embodiment, a scanned beam display may include a photoluminescent display screen including a two-dimensional array of cuplets containing a photoluminescent material. At least one light source may be modulated to output light at a first wavelength according to received image information. A beam output from the at least one light source is periodically scanned across a field of view that includes the photoluminescent display screen having cuplets. The scanned beam sequentially excites photoluminescent material positioned corresponding to the cuplets, and light is responsively output by the photoluminescent material in a pattern corresponding to the received image information. The cuplets may be configured to direct the light output along a preferred direction, such as to provide gain in a preferred viewing direction.

According to another embodiment, a scanned beam display includes at plurality of light sources operable to produce respective modulated beams of light at a corresponding plurality of wavelengths. The respective beams are scanned across a screen by a beam director. The screen may be configured to operate as a photoluminescent wavelength converter for received light at one or more wavelengths and as an exit pupil expander (EPE) for light received at other wavelengths. A plural wavelength image may be formed for viewing from the screen. The plural wavelength image may include at least a first wavelength produced by a light source and propagated by the screen. The plural wavelength image may include at least a second wavelength photoluminescently emitted by a photoluminescent material responsive to a received scanned beam at a third wavelength, the third wavelength beam being produced by another of the light sources. One or more arrays of optical surfaces may be formed in the screen. An array of optical surfaces may act as a microlens array (MLA) to the first wavelength to expand the exit pupil of the received and propagated beam. An array of optical surfaces may act as cuplets to direct photoluminescently-produced light along a preferred output direction. The arrays acting as an MLA and as cuplets may be the same array or different arrays. The optical surfaces may be shaped to provide substantially overlapping viewing regions for the propagated and the photoluminescently-produced wavelengths.

According to an embodiment, a screen may include an array of cuplets including an incident surface that reflects light at a second wavelength λ₂ and transmits light at a first wavelength λ₁. This cuplet surface directs generated light of wavelength λ₂ toward an output direction, enhancing the intensity of light of wavelength λ₂ in the output direction.

According to another embodiment, cuplets within the display screen may be broadband reflecting on portions of their surfaces. The cuplet reflective coating may be patterned with a pinhole aperture entrance. Photoluminescent material may receive light of a first wavelength λ₁, through the pinhole aperture entrance of the cuplets and responsively emit light of a second wavelength λ₂. The broadband reflecting cuplet surfaces may direct the generated light of wavelength λ₂ toward an output direction.

According to another embodiment, an exit pupil expander includes a microlens array (MLA) wherein the MLA contains photoluminescent material within the microlenses. Upon receiving light having first wavelength λ₁, the photoluminescent material may generate light having second wavelength λ₂. If the incident beam includes other wavelengths, the MLA may also expand the other wavelengths as transmitted beamlets of the other wavelengths. Light emitted by the photoluminescent material may then be output substantially superimposed with beamlets of transmitted light to form an image having a plurality of wavelengths for viewing by a viewer.

According to another embodiment, the rear surface of the MLA may be operative to transmit light at the first wavelength, reflect light at the second wavelength, and refract light at the other wavelengths. According to other embodiments, the rear surface of the MLA may be broadband reflective in a pattern that allows the entrance of the first wavelength and other wavelengths through a portion thereof, while reflecting forward light at the second wavelength that is emitted in undesirable directions.

According to another embodiment, the screen may be formed as a dual microlens array (DMLA) separated by a distance substantially equal to the focal lengths of the individual microlens arrays. According to some embodiments, the first or second (output side) of the DLMA arrays may include a photoluminescent material operative to receive light at a first wavelength and to emit light at a second wavelength.

According to another embodiment, a scanned beam display system including an EPE containing photoluminescent material may contain modulation electronics that modulates one or more wavelengths of light, e.g., modulation electronics may modulate a plurality of wavelengths λ₁, λ₃, λ₄, according to pixel values received from a video source. Light of first wavelength λ₁ may be modulated according to an image pixel color and intensity, and then may be input to the exit pupil expander, which may output light of another wavelength λ₂ having a modulated pattern corresponding to modulated wavelength λ₁. The scanned beam display system may output an image having an expanded exit pupil including modulated wavelengths λ₂, λ₃, and λ₄.

### BRIEF DESCRIPTION OF THE DRAWINGS

Aspects and advantages according to embodiments will become more readily appreciated by reference to the following non-limiting detailed description, when taken in conjunction with the accompanying drawings.

FIG. 1 is a block diagram of a scanned beam display according to an embodiment.

FIG. 2 is a side sectional view of a display screen according to an embodiment.

FIG. 3 is a side sectional view of a display screen according to another embodiment.

FIG. 4 is a side sectional view of a display screen according to another embodiment.

FIG. 5 is a side sectional view of a display screen showing light paths according to an embodiment.

FIG. 6 is a side sectional view of a display screen showing light paths according to another embodiment.

FIG. 7 is a block diagram of a scanned beam display having plural wavelengths according to an embodiment.

FIG. 8 is a side sectional view of a display screen showing plural wavelength light paths according to an embodiment.

FIG. 9 is a side sectional view of a photoluminescent display screen according to an embodiment using microspheres as cuplets.

FIG. 10 is a side sectional view of a photoluminescent display screen according to another embodiment using ground and polished microspheres as cuplets.

### DETAILED DESCRIPTION

The following discussion is presented to enable a person skilled in the art to make and use the invention. The general principles described herein may be applied to embodiments and applications other than those detailed below without departing from the spirit and scope.

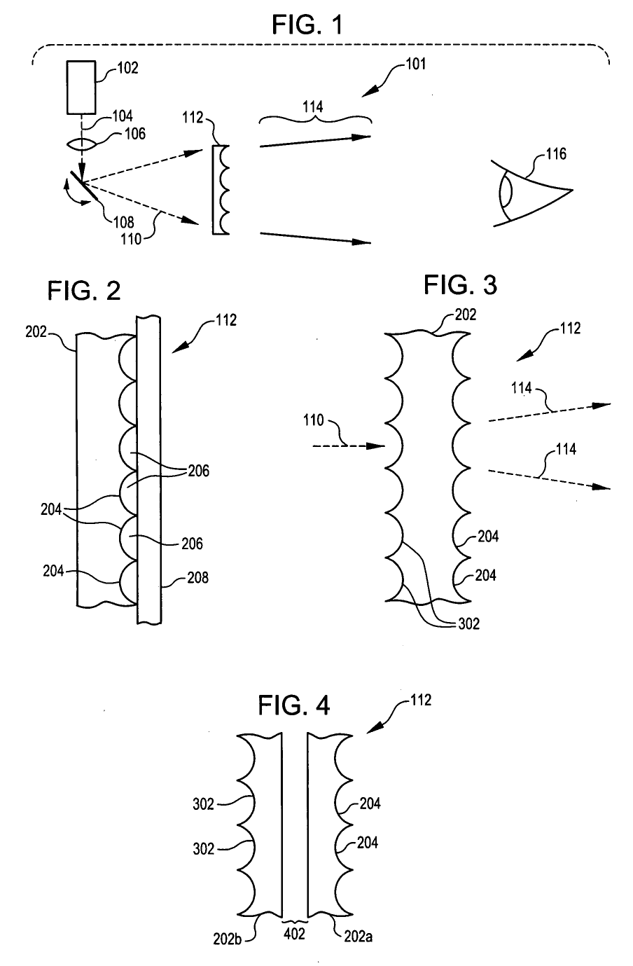

FIG. 1 is a block diagram of a scanned beam display 101 according to an embodiment. A first light source 102 is operable to emit a modulated beam 104 at a first wavelength. The beam may be shaped by beam shaping optics 106 and scanned in a periodic pattern by a beam scanner 108 to form a scanned beam 110. A screen 112 may be placed in the field of view of the scanned beam. The screen 112 may be configured to convert received light at the first wavelength to viewable light 114 at a second wavelength. The light 114 may be projected forward at an angle toward the eye of a viewer 116. The forward projection angle may be selected to minimize the amount of second wavelength light emitted backward toward the beam scanner and at a diverging or converging angle selected to balance the size of the viewing region (exit pupil) against the gain of the screen (efficiency). Generally speaking, larger viewing angles may be appropriate for applications involving a larger variety of user eye placements relative to the screen 112; and smaller viewing angles may be appropriate for applications that seek to maximize apparent display brightness relative to the projected light 114 power. As will be seen, selection of feature shapes and properties in the screen 112 may be used to tailor the viewing angle to a given application.

One example of a scanning mirror 108 is a mechanically resonant scanner, such as that described U.S. Pat. No. 5,557,444 to Melville et al., entitled MINIATURE OPTICAL SCANNER FOR A TWO-AXIS SCANNING SYSTEM, incorporated herein by reference.

According to some applications, the emitted beam may be non-visible, such as ultraviolet or infrared, and the viewable light may be at a visible wavelength. For example, the light source 102 may be an infrared laser diode operable to emit a first wavelength in the infrared, such as 1024 nanometers (nm), for example; and the screen 112 may be configured to generate a second harmonic output at a visible green wavelength 512 nm half that of the impinging scanned beam 110. According to another example, the light source 102 may be a violet laser diode operable to emit a first wavelength at about 405 to 415 nm and the screen may be configured to photoluminescently emit light at a second, longer wavelength, such as about 512 nm for example.

While the display screen 112 is illustrated as being directly viewed, the output from the display screen may alternatively be received and projected by relay or projection optics. For example, the image formed at the plane of the display screen 112 may be rear- or front-projected onto a final viewing screen. Alternatively, an ocular assembly may project the image onto the viewer's retina, optionally while changing the wavefront curvature, and hence the apparent distance from the screen 112 to the eye 116.

FIG. 2 is a side sectional view of a display screen 112 according to an embodiment. A substrate 202 includes an array such as a two-dimensional array of surfaces 204 configured to form cuplets 206 on a surface of the substrate. The cuplets may include a wavelength conversion material held therein. According to an embodiment, the surfaces 204 may be configured to transmit some or all of the received first wavelength light and reflect some or all of impinging second wavelength light, thus admitting the first wavelength to the wavelength converting material and reflecting some or all of the responsively emitted second wavelength light forward. In the case where the first wavelength is violet light and the second wavelength is green, the surface transmission and reflection properties may be termed violet-transmit-green-reflect (VTGR). According to another example where the first wavelength light is infrared and the second wavelength is green, the surface transmission and reflection properties may be termed infrared-transmit-green-reflect (ITGR).

Optionally, a cover 208 may be placed over the array of cuplets. The cover 208 may include a filter configured to reflect first wavelength light and transmit the second wavelength light.

According to some embodiments, the surfaces 204 defining the edges of the cuplets may be optical surfaces such as spherical surface, paraboloid surfaces, hyperboloid surfaces, or other aspherical surfaces selected to provide a desired intensity pattern of emitted viewable light 114. As will be explained below, the surfaces 204 may further include an optical shape selected to refract, diffract, or reflect light having wavelengths other than the first or second wavelengths.

FIG. 3 is a side sectional view of a display screen 112 according to another embodiment. A substrate 202 includes a first array of surfaces 204 defining the edges of cuplets. A second array of optical surfaces 302 may be defined on the opposite surface of the substrate 202. According to some embodiments, each first surface 204 is formed opposite a corresponding second surface 302. An input beam 110 containing at least a first wavelength is scanned across the second array of optical surfaces 302. The second array of optical surfaces reflects, refracts, or diffracts the input beam 110 toward the corresponding elements of the first array of surfaces. The first array of surfaces 204 may also act as diffracting, reflecting, or reflecting optical elements to at least some wavelengths of light. Accordingly, the pair of arrays may operate as a dual micro-lens array (DMLA). When configured as a DMLA, corresponding elements of the first and second arrays of optical surfaces 204, 302 may typically be positioned one focal length apart. According to some embodiments, the first and second arrays of optical surfaces 204, 302 are formed as planar arrays that are parallel to one another. According to alternative embodiments, the first and second arrays of optical surfaces 204, 302 may be formed on curved surfaces such as spherical surfaces that are positioned one focal length apart.

FIG. 4 is a side sectional view of a display screen 112 according to another embodiment wherein the substrate is split into two components 202a and 202b that are separated by a gap 402, which may for example be an air gap. An array of microlens surfaces 302 on the first substrate component 202b may be operative as described above. An array of cuplets 204 may be formed on the second substrate component 202a. The cuplets may be formed or coated to contain photoluminescent material.

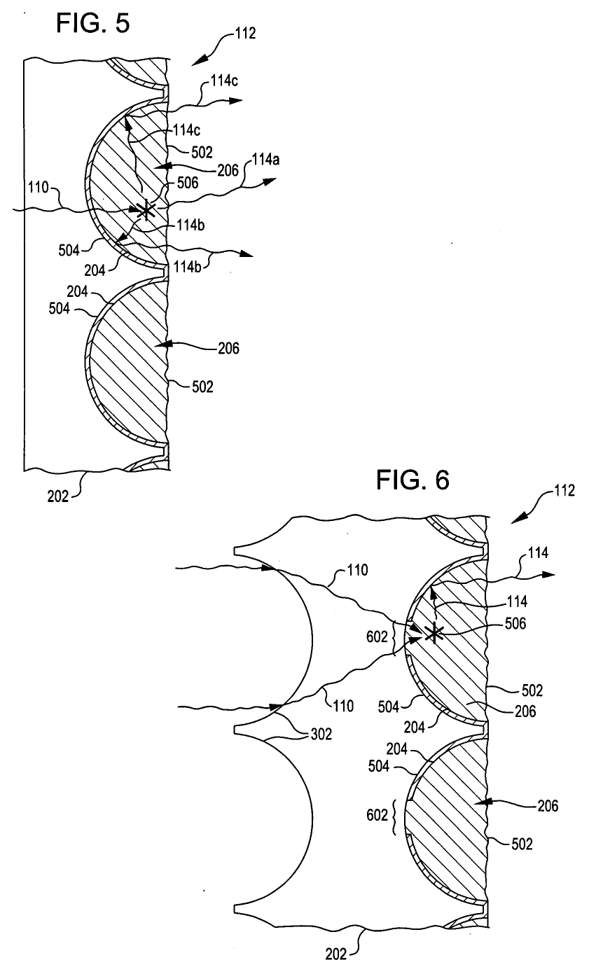

FIG. 5 is a side sectional view of a display screen 112 showing light paths according to an embodiment. The substrate 202 includes an array of optical surfaces 204 defining the edges of cuplets 206. According to the embodiment, the optical surfaces 204 include a selective mirror layer 504. As described above, the selective mirror layer 504 may be configured to pass an incident light beam at a first wavelength 110, and reflect light at the second wavelength. An exemplary incident light beam at a first wavelength 110 is illustrated penetrating the substrate 202, an optical surface 204, and a selective reflector 504 disposed thereon to enter a cuplet 206.

A wavelength-converting material is formed within or beyond the cuplet that is operative to receive the incident first wavelength of light and convert it to a second wavelength of light. As illustrated, a portion of the incident beam 110 at a first wavelength is received at a wavelength converting entity 506 and converted to a second wavelength of light. Three potential output paths are illustrated. In the output path 114a, light is emitted forward toward a viewing area. In second and third output paths 114b and 114c, light is emitted generally back toward the scanner and generally sideways along the array of cuplets respectively. The emitted light is reflected by the selective reflector 504 and directed forward toward a viewing area. Thus, the reflectance and shape of the optical surface 204 defining the cuplet can determine the range of angles over which light at the second wavelength is directed toward the viewing area. Shallower cuplets may direct the second wavelength light forward at a relatively wider range of angles such as to, for example, allow a shorter path length to a subsequent optional optical element, allow a larger subsequent optical element, or allow viewing across a wider range of angles such as nearly a half plane or an optical half angle of 0-30 degrees or less. Deeper cuplets may direct the second wavelength light forward at a relatively narrower range of angles such as to, for example, allow a longer path length to an optional subsequent optical element, allow a smaller optional subsequent optical element, or allow viewing across a narrower range of angles such as, for example 0-15 degrees optical half angle or less. A narrower viewing angle may concentrate output light across the viewable area and make the display appear relatively brighter.

While emitted light projected in a rightward direction in FIG. 5 has been described as being projected into a viewing area, the output from the display screen 112 may optionally be output to projection or relay optics, a final diffuse viewing screen, etc.

Although the wavelength converting material is shown substantially filling the cuplets, the material may be distributed non-uniformly within the cuplets. For example, a transparent layer may be formed around the edges of the cuplets and the wavelength converting material may be concentrated near a focus or foci. Alternatively, the wavelength converting material may be disposed within an overlying plane of material 208 (not shown).

As indicated above, a number of wavelength converting materials may be appropriate to provide various types of wavelength conversion. For example, a slab, a piece, or a plurality of pieces of periodically-polled lithium niobate may act as a second harmonic generator and result in a second wavelength half that of the first wavelength. Alternatively, down-converting or up-converting photoluminescent materials may be used to shift wavelengths by differing amounts.

Examples of materials suitable for the wavelength converting material 502 include, but are not limited to, green emitting phosphors such as zinc sulfide doped with copper and aluminum (ZnS:Cu,Al), blue emitting phosphors such as (SrCaBa)₅Cl(PO₄)₃:Eu, and red emitting phosphors such as Mg₄F₁GeO₆:Mn. Fluorescent dyes such as coumarin, fluorescein, and rhodamine; nanoparticles (e.g., quantum dots) supported by or dispersed in liquids or solids; doped crystal solids such as neodymium doped yttrium aluminum garnet (Nd:YAG)(Y₃Al₅O₁₂:Nd); and doped glasses are other materials that may be suitable for the photoluminescent material 502. The photoluminescent material 502 may be of a type described in, for example; Shigeo Shionoya and William M. Yen, eds, PHOSPHOR HANDBOOK, CRC Press (1999); Wise, Donald L. et al., eds, PHOTONIC POLYMER SYSTEMS, Marcel Dekker (1998); and/or Berlman, Isadore B., HANDBOOK OF FLUORESCENCE SPECTRA OF AROMATIC MOLECULES, Academic Press (1965); all hereby incorporated by reference. The photoluminescent material 502 may alternatively exhibit fluorescent or phosphorescent characteristics, consistent with the decay requirements necessitated by frame duration.

FIG. 6 is a side sectional view of a display screen 112 showing light paths according to another embodiment. A substrate 202 includes a first array of optical surfaces 204 defining the edges of cuplets 206. According to the embodiment, the optical surfaces 204 include a mirror layer 504 having one or more apertures 602 formed therein. The mirror layer 504 and aperture 602 may be configured to pass light through the aperture and reflect light elsewhere.

A second array of optical surfaces 302 may be defined on the opposite surface of the substrate 202 as shown. According to some embodiments, each first surface 204 is formed opposite a corresponding second surface 302. The second array of optical surfaces reflects, refracts, or diffracts the input beam 110 toward the corresponding elements of the first array of surfaces. The second array of surfaces 302 may act as diffracting, reflecting, or reflecting optical elements to at least some wavelengths of light.

An exemplary incident light beam 110 at a first wavelength 110 is illustrated refracted by a second optical surface 302, penetrating the substrate 202, and passing through an aperture 602 in the mirror 504 into a cuplet 206. As described above, a wavelength-converting material is formed within or beyond the cuplet that is operative to receive the incident first wavelength of light and convert it to a second wavelength of light. As illustrated, at least a portion of the incident beam 110 at a first wavelength is received at a wavelength converting entity 506 and converted to a second wavelength of light. One potential output path 114 is illustrated. The reflectance and shape of the optical surface 204 defining the cuplet and the size of the aperture 602 can determine the range of angles over which light at the second wavelength is directed toward the viewing area. Considerations may be similar to those described above. As one alternative to refracting input light 110, the second array of optical surfaces may form light gathering reflective surfaces configured to direct received light toward an aperture formed in the rightmost tip thereof. In some embodiments, the reflective surfaces may be hyperboloid in shape.

Referring back to FIG. 1, according to some embodiments, the beam shaping element 106 may include a top-hat lens or diffractive element. A top-hat beam propagates from a top-hat shape having substantially uniform power across its cross-section to a sinc shape (sin x/x) having concentrated power at its center. Especially when a reflector with aperture such as the embodiment of FIG. 6 is used, it may be advantageous to include a top hat converter in the beam path having a focal length to create a sinc shape at a distance corresponding to the wavelength converting screen 112. Such an approach can result in a relatively large portion of incident beam power being “threaded” through the one or more apertures 602, thus resulting in enhanced efficiency.

As an alternative to refracting surfaces 302, the walls 302 of the shapes on the input side of the display screen 112 may be formed as reflecting surfaces. According to an embodiment, the shape of the input surfaces may be formed as hyperboloid, paraboloid, etc. configured to reflect incident light energy toward a focus substantially corresponding to the input aperture 602 of the cuplets 206.

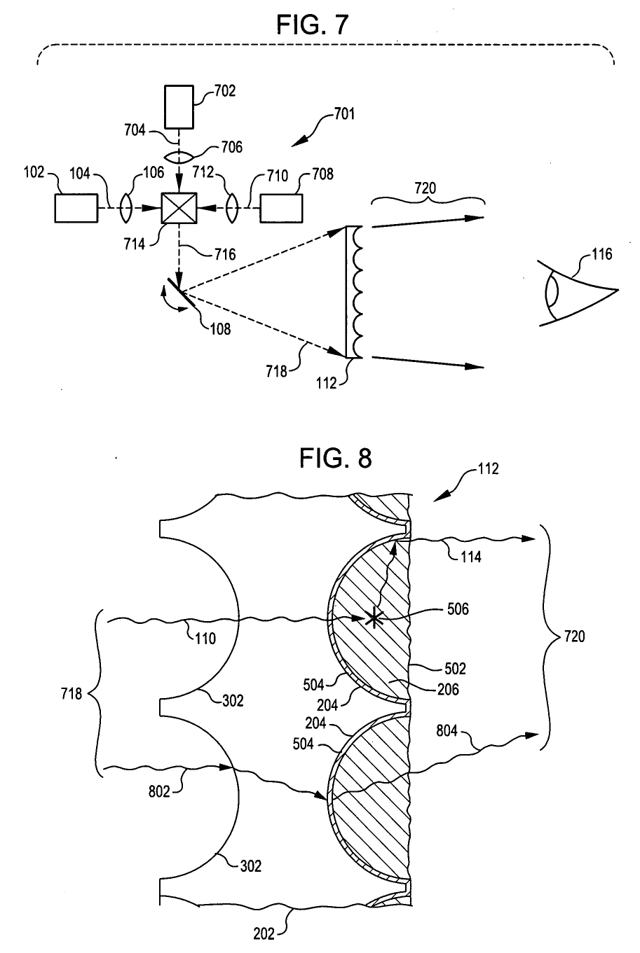

FIG. 7 is a block diagram of a scanned beam display 701 having plural wavelengths according to an embodiment. As with the display 101 of FIG. 1, a light source 102 is operable to emit a modulated beam of light 104 at a first wavelength through an optional beam shaping optic 106. The beam is scanned in a periodic pattern by a beam scanner 108 across a field of view including a display screen 112. The display screen 112 is configured to convert the first wavelength to a second viewable wavelength that may be viewed by a viewer's eye 116. Additionally one or more second light sources 702 and 708 are operable to emit respective beams of light 704, 710 at third and fourth wavelengths through respective optional beam shaping optics 706, 712. A beam combiner 714 is aligned to receive the modulated beams 104, 704, and 712 and combine them into a composite modulated beam 716 that is scanned by a beam scanner 108 across a field of view as a composite modulated scanned beam 718. The screen 112 is operable to pass the third and fourth wavelength light in combination with the converted second wavelength light toward the viewer's eye 116 as a plural wavelength viewable image 720. As with the apparatus of FIG. 1, the light sources 102, 702, and 708 may be modulated synchronously with the scanning of the beam 718 to produce a viewable video image 720 corresponding to a received video signal (not shown).

FIG. 8 is a side sectional view of a display screen 112 showing plural wavelength light paths according to an embodiment. While the light paths are, for clarity, shown separately, the light paths may be superimposed. A first wavelength component 110 of the incident beam 718 is received by an optional array of second optical surfaces 302 and penetrates a substrate 202 toward and through an array of first optical surfaces 204 defining an array of cuplets 206. The first optical surfaces 204 include a selectively reflective coating 504 configured to pass the first wavelength. As described above, a wavelength-converting material 502 is formed within or beyond the cuplets that is operative to receive the incident first wavelength of light and convert it to a second wavelength of light. As illustrated, at least a portion of the incident beam 110 at a first wavelength is received at a wavelength converting entity 506 and converted to a second wavelength of light. One optional output path 114 is illustrated wherein the reflectance and shape of the optical surface 204 and the selectively reflective coating thereon define a range of angles over which light at the second wavelength 114 is directed toward the viewing area. Considerations may be similar to those described above.

Third and fourth wavelength components 802 of the incident beam 718 are refracted by the optional second array of optical surfaces 302 and directed toward the corresponding first array of surfaces 204. The selectively reflective surface 504 of the first array of surfaces is configured to pass the third and fourth wavelengths. A contrasting index of refraction between the substrate 202 and the opposite side of the first optical surfaces (I.e., the interior of the cuplets) causes refraction to occur at the first optical surfaces. Accordingly, the transmitted third and fourth wavelength components of the viewable light 720 are propagated to form beamlets in the far field having and expanded exit pupil formed by the DMLA of the screen 112. According to some embodiments, the divergence angle of the second wavelength light 114 may be matched to the range of beamlet angles of the third and fourth wavelength light 804 to form a plural color image that is viewable over an expanded exit pupil.

According to some embodiments, the first light source 102 is a violet laser diode operable to emit a first wavelength in the violet range of the spectrum such as around 408 nm, the second light source 702 is a blue laser diode operable to emit a third wavelength in the blue range of the spectrum such as around 420 nm, and the third light source 708 is a red laser diode operable to emit a fourth wavelength in the red range of the spectrum such as around 625 nm. The selectively reflective coating 504 may include a green-reflecting notch reflector that is operable to transmit violet, blue, and red light but reflect green light. Other combinations of wavelengths may similarly be used.

FIG. 8 is a side sectional view of a photoluminescent (and optionally exit pupil expanding) display screen made according to an alternative manufacturing process and having alternative structural embodiments.

A monolayer of microspheres 902 containing wavelength converting material are disposed upon a first surface of a substrate 202. The microspheres 902 form cuplets 206. The microspheres 902 may be adhered to the substrate with a substantially transparent optical adhesive 904. Alternatively, the optical adhesive 904 may be selected or formulated to reflect received light 110 at a first wavelength and to transmit photoluminescently emitted light at a second wavelength. According to one embodiment, a contrasting refractive index between the top surface of the microspheres 902 and an overlying material 906 may provide at least partial preferential reflection of photoluminescently emitted light energy in the downward direction. According to an embodiment, the overlying material 906 may consist substantially of air, dry air, carbon dioxide, argon, or other gas. According to another embodiment, the overlying material 902 may comprise a fluid. According to another embodiment, the overlying material 906 may comprise a cured polymer selected or configured to transmit received light 110 at a first wavelength and reflect photoluminescently emitted light at a second wavelength. Optionally, a filter 208 may be disposed one or both surfaces of the substrate 202. According to an embodiment, the filter 208 may be configured to reflect or absorb incident light 110 at the first wavelength and transmit photoluminescent light at the second wavelength.

Alternatively, the display screen configuration describe above may be altered somewhat. For example, the incident light 110 may be violet and may impinge upon the display screen 112 from the bottom. The filter layer 208 may be omitted. The optical adhesive 904 may be configured or selected to transmit violet light and reflect visible light such as green light (VTGR). The overlying layer 906 may substantially comprise viewing room air, may comprise a dry gas or a fluid, or may comprise a green transmitting, violet reflecting (GTVR) material such as a polymer, suspension, vacuum/plasma deposited layer or other material construction.

FIG. 10 illustrates an alternative embodiment for providing display screen functionality that, like an alternative embodiment described above, may be configured as a back illumination screen arranged to receive an incident modulated beam of light 110 from the bottom.

A monolayer of microspheres of wavelength converting material 902 may be disposed on a substrate 202 to form cuplets 206. According to an embodiment, the microspheres 902 may be joined to the substrate with an optical adhesive 904. The microspheres may be provided a coating 504 of VTGR material. Additionally or alternatively the optical adhesive 904 may be configured as a VTGR material. After curing the monolayer thus deposited on the substrate 202, the output face 1002 may be ground to substantial flatness, surface peened, abrasive jet treated, or otherwise treated to expose the inner portion of the cuplets 206 substantially without an overlying VTGR layer. The output face 1002 may then be polished, coated, and/or may be otherwise treated to best provide desired mechanical, optical, visual, electrical, or other requirements.

Of course, the embodiment shown in FIG. 10 may also be configured as a front-illuminated component. In the case of front-illumination, the optical properties of the microspheres 902, microsphere coating 504, optical adhesive 904, and/or the substrate 202 may be adjusted as illustrated above.

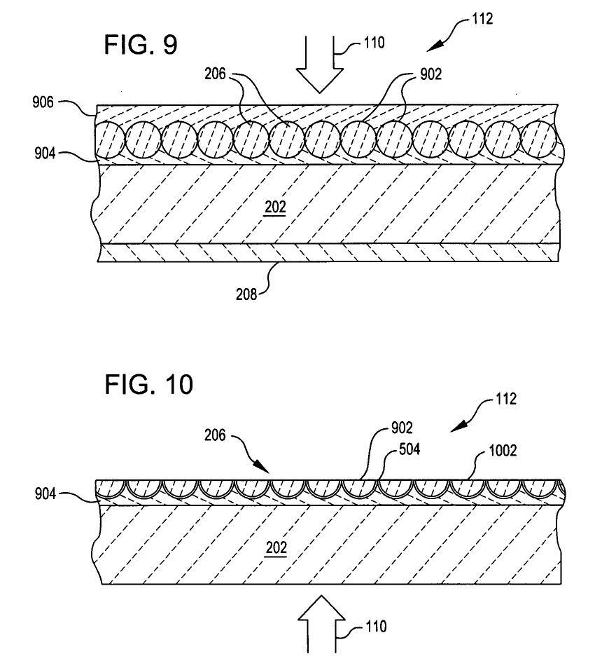

While the microsphere layers shown in FIGS. 9 and 10 are described as monolayers, other configurations are possible. For example, the layers of microspheres 902 may be substantially anamorphic, such as may be produced by screening a slurry of microspheres entrained in adhesive 904 onto the surface of the substrate 202. Plural layers of microspheres may be desirable according to some embodiments. According to other embodiments, the microspheres need not be actually spherical, but may comprise ground or powdered and classified material having faceted sides, cylinders, etc.

While the term photoluminescence and its derivatives have been used extensively throughout, the light emitted at the second wavelength 2 need not, strictly speaking, be the result of a purely photoluminescent process. As used herein, the term may extend to other processes such as second harmonic generation, surface plasmon resonance, etc.

From the foregoing discussion, it will be appreciated that, although specific embodiments of the invention have been described herein for purposes of illustration, various modifications may be made without deviating from the spirit and scope of the invention, which will be limited only by the claims.

1-32. (canceled)

33. A display screen comprising:
a substrate having first and second surfaces;
an array of cuplets disposed on a surface of the substrate configured contain a wavelength-converting material and to receive a beam of light at a first wavelength and responsively emit light at a second wavelength in a preferred direction.

34. The display screen of claim 33, wherein the substrate is substantially transparent to the first wavelength and the preferred direction is away from and substantially normal to a surface of the substrate.

35. The display screen of claim 33 wherein the substrate is substantially transparent to the second wavelength and the preferred direction is toward and substantially normal to the surface of the substrate.

36. The display screen of claim 33 wherein the cuplets comprise a two dimensional array of indentations in the first surface of the substrate.

37. The display screen of claim 33 wherein the cuplets substantially comprise a monolayer of microspheres disposed on the surface of the substrate.

38. The display screen of claim 33 further comprising a second substrate parallel to the first substrate and comprising a microlens array.

39. The display screen of claim 33 wherein the cuplets are disposed on the second surface of the substrate and further comprising an optical element array formed on the first surface of the substrate comprising at least one selected from the group consisting of a microlens array, a microsphere array, a second cuplet array, a micro reflector array, and a diffractive surface.

40. The display screen of claim 33 wherein the array of cuplets is configured to operate as a microlens array to a third wavelength.

41. The display screen of claim 33 wherein the display screen is further configured to operate as an exit pupil expander to a third wavelength and the expansion envelope of the exit pupil expander and the second wavelength emission envelope are substantially congruent.

42. The display screen of claim 33 further comprising at least one wavelength converting material held within the cuplets, the at least one wavelength converting material comprising at least one selected from the group consisting of a photoluminescent material, a fluorescent material, a phosphorescent material, an up converting material, a down converting material, a second harmonic generating material, a plasmon resonance material, a green emitting phosphor, zinc sulfide doped with copper and aluminum (ZnS:Cu,Al), a blue emitting phosphor, (SrCaBa)₅Cl(PO₄)₃:Eu, a red emitting phosphor, Mg₄F₁GeO₆:Mn, a fluorescent dye, coumarin, fluorescein, rhodamine, nanoparticles, quantum dots, a material supported by a solid, a material dispersed in a liquid, a doped crystal solid, neodymium doped yttrium aluminum garnet (Nd:YAG) (Y₃Al₅O₁₂:Nd), and a doped glass.

43. The display screen of claim 33 configured as one selected from the group consisting of an intermediate image plane, an image plane, an exit-pupil expander, a projection image source, and a direct view screen.

44. The display screen of claim 33 wherein each cuplet comprises a wall configured to transmit the first wavelength and reflect the second wavelength.

45. The display screen of claim 33 further comprising a filter configured to substantially prevent light at the first wavelength from propagating in the preferred direction.

46. A scanned beam display comprising:
a light source operable to emit a modulated beam of light at a first wavelength;
a beam director operable to scan the modulated beam of light in a periodic pattern; and
a display screen configured to receive the modulated beam of light at the first wavelength and responsively emit a corresponding pattern of light at a second wavelength;
wherein the display screen comprises a two-dimensional substrate having first and second surfaces; and
a two-dimensional array of cuplets disposed on at least one of the first and second surfaces configured to at least partially contain at least one wavelength converting material and to substantially reflect light at the second wavelength along a preferred axis.

47. The scanned beam display of claim 46 operable as a retinal scanning display and wherein the display screen is configured as an exit pupil expander.

48. The scanned beam display of claim 46 configured as a projection display, further comprising projection optics, and wherein the display screen is configured as an image source for the projection optics.

49. The scanned beam display of claim 46 configured as a direct-view display and wherein the display screen is configured for substantially direct viewing.

50. The scanned beam display of claim 46 wherein the second wavelength is visible light and the first wavelength is substantially outside the visible spectrum.

51. The scanned beam display of claim 46 further comprising a light source operable to emit a second modulated beam of light at a third wavelength;
wherein the beam director is further operable to scan the second modulated beam of light in the periodic pattern; and
wherein the display screen is further configured to receive and transmit the modulated beam of light at the third wavelength.

52. The scanned beam display of claim 46 further comprising:
a light source operable to emit a second modulated beam of light at a third wavelength;
wherein the beam director is further operable to scan the second modulated beam of light in the periodic pattern; and
wherein the display screen is further configured to receive and expand the modulated beam of light at the third wavelength.

53. The scanned beam display of claim 46 further comprising:
a light source operable to emit a second modulated beam of light at a third wavelength;
wherein the beam director is further operable to scan the second modulated beam of light in the periodic pattern;
wherein the display screen is configured to support a diffuse image at the second wavelength; and
wherein the display screen is further configured to receive the modulated beam of light at the third wavelength and support a diffuse image at the third wavelength substantially coincident with the diffuse image at the second wavelength.

54. A method for displaying an image comprising the steps of:
receiving at an array of cuplets disposed on a viewing screen, a modulated scanned beam of light at a first wavelength;
converting the first wavelength to a second wavelength; and
preferentially directing the light at the second wavelength from the viewing screen toward a viewing position.

55. The method of claim 54 wherein the light at the second wavelength is directed along a direction having a transverse angular extent less than about 60 degrees optical half-angle.

56. The method for displaying an image of claim 54 wherein the light at the second wavelength is directed along a direction having transverse angular extent of less than about 15 degrees optical half angle.

57. The method for displaying an image of claim 54 wherein the light at the second wavelength is preferentially directed by reflecting at least a portion of the light at the second wavelength off surfaces of the first plurality of cuplets.

58. The method for displaying an image of claim 54 wherein the surfaces of the cuplets are substantially one selected from the group consisting of paraboloid, hyperboloid, spherical, cylindrical, and faceted.

59. The method for displaying an image of claim 54 further comprising the steps of:
receiving at the viewing screen a modulated scanned beam of light at a third wavelength; and
preferentially directing the light at the third wavelength from the viewing screen toward the viewing position.

60. A photoluminescent display screen comprising:
a first sheet having lateral extent comprising a plurality of cuplets formed therein, wherein each of the plurality of cuplets comprises within its volume a photoluminescent material operable to receive light at a first wavelength and responsively emit light at a second wavelength.

61. The photoluminescent display screen of claim 60, further comprising, for each of the plurality of cuplets, one of:
a wall operable to transmit light at the first wavelength and reflect light at the second wavelength; and
a wall made from material that is operable to reflect all optical wavelengths, the wall containing an aperture that permits all optical wavelengths to propagate to within the cuplet.

62. The photoluminescent display screen of claim 60 wherein the first sheet is operable to receive a beam of light at the first wavelength from a direction substantially normal to a first surface; and
wherein the cuplets are further operable to direct at least a majority of the responsively emitted light at the second wavelength in a direction comprising a major axis substantially normal to a second surface of the sheet, in a substantially Lambertian pattern having an emission numerical aperture.

63. The photoluminescent display screen of claim 60 wherein the cuplets are further operable to transmit light at a third wavelength.

64. The photoluminescent display screen of claim 63 wherein the plurality of cuplets are operable to receive a beam of light at the third wavelength and expand the beam to a far field pattern comprising beamlets.

65. The photoluminescent display screen of claim 64 wherein the angular extent of the beamlets is approximately equal to the angular extent of the emission numerical aperture.
